(19) United States
(12) Patent Application Publication
(10) Pub. No.: US 2023/0142649 A1
(43) Pub. Date: May 11, 2023

(54) PROCESS OF CATALYTIC CRACKING OF SOLID WASTE FROM PINE DERIVATIVES INDUSTRY

(71) Applicant: WOODCHEM S.A., Leiria (PT)

(72) Inventors: Manuel BARBEIRO COSTA, Leiria (PT); João Abel Gonçalo RODRIGUES AFONSO, Fátima (PT); João Carlos MOURA BORDADO, Lisboa (PT); Rui Miguel GALHANO DOS SANTOS LOPES, Parede Cascais (PT)

(73) Assignee: WOODCHEM S.A., Leiria (PT)

(21) Appl. No.: 17/920,420

(22) PCT Filed: Apr. 23, 2020
(86) PCT No.: PCT/PT2020/050016

§ 371 Date: Oct. 21, 2022

(51) Int. Cl. C10G 1/08; C10G 1/00

(52) U.S. Cl. CPC C10G 1/083; C10G 1/002; C10G 2300/1003; C10G 2300/1014

(57) ABSTRACT

A process for catalytic cracking of waste originating from pine processing industry for producing a mixture of chemical compounds, e.g., components for formulation of adhesives, foams, antioxidants, sugars, among others. Optionally, additional steps can be added to the process for processing the obtained mixtures in order to obtain purer fractions with greater commercial interest and value.

### FIELD

The present invention pertains to the field of the production of sustainable chemical products as an alternative to those derived from petroleum, with industrial interest.

### BACKGROUND

The chemical and fuel industry continues to strongly rely on fossil resources. This dependence results from the costs associated with the processes for producing sustainable products of natural origin which preclude the industrialization of more sustainable alternatives. However, a change to this paradigm is highly desired and needed. Therefore, there is an urgent need to develop and research new processes, industrially cost-effective.

The new paradigm of researching alternative and new processes using waste has been a subject of great interest in the recent years. There has been a significant increase of studies on the chemical conversion of this waste into products having potential to be used in the chemical industry as an alternative to those derived from fossil resources. These new products are sustainable as they originate from renewable natural resources.

Within the scope of this new paradigm, the present invention aims to produce chemical products with industrial interest through a new process based on a process modified on the base of the catalytic cracking of waste originating from pine processing industry.

According to the present invention chemical products are obtained, which are stable, sustainable and cost-effective, having great interest in the chemical industry, from the catalytic cracking of waste originating from pine processing industry, which may, or not, contain plastics, paper or glue residues.

Currently, said waste is generally underused, being employed, e.g., as a solid fuel for burning in biomass power plants or thermal boilers, or even disposed in landfills.

There are several chemical processes for converting waste into value-added chemical products. These include fast pyrolysis, gasification, the Fischer-Tropsch process, hydrothermal liquefaction and also thermochemical liquefaction with proton donor solvents.

However, all these processes involve solvents originated from fossil resources and expensive, or have high operating costs and in some cases have low yields.

In the case of fast pyrolysis, even changing the experimental conditions and with very extensive studies of the process, overall yields of less than 50% are often obtained. It should be also noted that many chemical reactions, which occur during the process, lead to formation of small molecules, aldehydes and unsaturated fragments, making the obtained product mixtures quite unstable, always requiring further treatment to stabilize those mixtures. The bio-oil formed has usually around 20% of water, not easy to separate, and with a notorious negative effect on the calorific power.

Gasification transforms the starting materials into syngas, which can later be converted into liquid products. However, this process has overall conversion rates that rarely exceed 18-20%, further resulting in fractions of chemical products with industrial interest below that percentage.

The Fischer-Tropsch process is a chemical process for producing liquid hydrocarbons from syngas. The obtained liquid hydrocarbons, mainly aliphatic linear (waxes), can subsequently be used in a number of synthetic pathways. However, in order for this process can be applied it will be required to previously use the gasification process. This combination of processes makes the overall process more complex and costly both from the perspective of the investment and also of the operating costs. Another disadvantage of this combination of processes is that it leads to rather low conversion rates, often lower than 15%.

Hydrothermal liquefaction can be used to convert raw materials, from various natural sources, into chemical products. This process allows the conversion of the initial products, which may comprise high percentages of water, in an aqueous medium and using high temperatures and pressures, into chemical products with industrial interest. However, this process requires large investment, and equipment of considerable size due to the high amount of water required for the process. This process further leads to products with significant moisture contents, which is disadvantageous, requiring subsequent drying of the obtained products.

The process herein described and claimed leads to conversion rates above 90% (on a dry basis) of fractions of chemical products of interest from waste originating from pine processing industry, which may, or not, contain plastics, paper or glue residues, having low moisture content.

There are several processes for converting raw materials originating from natural sources, namely the lignocellulosic ones, into products commercially and chemically valuable. However, many of these processes are complicated, have limitations, low yields and, in some cases, are economically costly which precludes its implementation on an industrial scale.

In the particular case of wood, this raw material has already been extensively studied, having its potential been evaluated as a feedstock for conversion into valuable products which can later be used in the most diverse applications. (Pan H., Renewable and Sustainable Energy Reviews 15 (7) p.3454, 2011).

Another previously disclosed patent, PT108816, refers to a liquefaction plant conceiving a single reactor for transforming biomass into bio-oil, at atmospheric pressure and moderate temperatures, which process differs from the process of the present invention which is carried out in two reactors in series. This new process includes also a distillation column for fractionating the bio-oil, after separation of the sugars by liquid-liquid extraction.

Patent application EP2313358 (A1) of 2011 Apr. 27 describes a liquefaction process which contemplates a reactor working at high pressures and with basic catalysts, contrary to the present invention.

Patent application WO 2012/150043 by Kunaver et al. describes a process for obtaining fuels from materials containing mainly cellulose, whereas in the present invention all materials regarded as waste are conceived, regardless of their cellulose content, not including the functional additives that are essential in this process.

All the above mentioned processes have problems, of which the following stand out, high temperatures, high pressures, obtention of bio-oil with high moisture content, high ash percentage and a low conversion rate.

### SUMMARY

The above listed problems are solved by the present invention through a process for catalytic cracking of waste originating from pine processing industry, using solvents of natural origin or which are industrial waste i.e., non-petroleum based solvents, and catalysts at low temperatures and atmospheric pressure, obtaining a substantially anhydrous bio-oil, with less than 1% of water with very low ash percentages (less than 1%) and with high conversion rate, i.e. bio-oil yield, usually higher than 90%.

In order to achieve this object, the present invention provides a process for catalytic cracking of waste originating from pine processing industry for producing a mixture of chemical compounds, e.g., components for formulation of adhesives, foams, antioxidants, sugars, among others. Optionally, supplementary steps can be added to the process for processing the obtained mixtures in order to obtain purer fractions with greater commercial interest and value. Within the obtained fractions, those resulting from the fractional distillation process find use as fuels whenever located in the boiling point range de gasoline, diesel or heavy fuel oil.-

Therefore, the process according to the present invention comprises the following steps:

a) grinding waste originating from pine processing industry into a particle size between 0.5 mm and 75 mm;
b) spraying a solution of a solvent of natural origin or a liquid industrial waste and a catalyst in homogeneous phase over the waste originating from pine processing industry;
c) introducing the mixture of step b) into a first reactor at temperatures between 80° C. and 250° C.;
d) maintaining the mixture of step b) under vigorous stirring at atmospheric pressure in a first reactor for a period of time between 30 minutes and 180 minutes;
e) removing the solid residues obtained from the mixture of step d) by filtration on a basket filter;
f) reintroducing the solid residues obtained in step e) into the first reactor;
g) introducing the liquid fraction obtained in step e) into a second reactor at temperatures between 80° C. and 250° C.;
h) maintaining the liquid fraction of step e) in the second reactor for a period of time between 30 minutes and 180 minutes;
i) removing the solid residues obtained from the mixture of step h) by filtration on a basket filter;
j) storing the liquid mixture obtained in step i) in a storage tank, the liquid mixture consisting of a substantially anhydrous bio-oil (less than 1% of water), with an ash percentage from 0% to 1% and with a bio-oil yield of more than 90%,
wherein, in order to avoid thermo-oxidative degradation, the process is carried out under a nitrogen atmosphere with flow rates between 3 m³/h and 5 m³/h.

In addition, the following steps can be carried out:

k) washing the liquid fraction obtained in step i) with water;

l) separating the aqueous and organic phases obtained in step k);
m) drying by distillation, at atmospheric pressure and single column, the organic fraction obtained in step 1);
n) fractionating the dried organic fraction obtained in step m) by fractional distillation, with a plate column, under vacuum and at temperatures between 100° C. and 250° C.;
o) storing in tanks the distilled fractions obtained in step n) and from the aqueous fraction in step k).

In the process according to the present invention a feedstock with a moisture content between 5% and 85% can be processed.

In step b) the catalytic cracking of waste originating from pine processing industry is initiated by the spraying over the waste, that is, when the same comes into contact with the solvent and the catalyst.

In step c) the first reactor is at temperatures preferably between 120 and 170° C.

The waste originating from pine processing industry which can have moisture contents between 5% and 55%, and may, or not, contain plastics, paper or glue residues, includes: pine bark, pinecones, pine nut shells, sawdust, abrasion dust from chipboards, pine chips, waste originating from manufacture of pine wood furniture, pine needles, stumps, among others.

The solvents used in the process typically are natural origin chemical products or industrial liquid waste, e.g., crude glycerol and glycerol derivatives, lactates and respective citrates, fatty acids, as well as esters or lactones thereof, glycerol carbonate, solketal, among others, said solvents being used pure or in mixtures.

The catalytic cracking occurs in steps b), c), d), e), g) and h) with a solvent percentage between 20% and 30% relative to the weight of the waste originating from pine processing industry which may, or not, contain plastics, paper or glue residues.

In the present invention the solvents or mixtures of solvents are selected from solketal, glycerol carbonate, glycerol formate, glycerol, Tall oil, turpentine among others.

The catalytic cracking occurs in steps b), c), d), e), g) and h) with a catalyst in homogeneous phase selected from trichloroacetic acid, nitric acid, hydrofluoric acid, sulfuric acid, p-toluenesulphonic acid, triflic acid and, generally, peracids and superacids, metal or semimetal carbonates, in an amount varying between 0.05% and 1.5% (w/w) of weight of catalyst relative to the total weight of the reaction mixture.

The conversion rate achieved under the above stated conditions is between 80%-99%.

Lignocellulosic materials containing plastics or rubbers can be processed by the process according to the present invention.

### EXAMPLES

### Example 1

In an initial phase, 600 kg of pine nutshell (10 mm particles), with 14% of moisture, were slowly and continuously added, through a feeder screw where 20% of a 1% solution of trichloroacetic acid in turpentine is introduced, into a first reactor containing 200 kg of turpentine and at a temperature of 160° C., with mechanical stirring. After 75 minutes the mixture is pumped into a basket filter where solid particles larger than 7 mm are separated, which are returned to the first reactor, while the liquid fraction and particles smaller than 7 mm are conveyed to a second reactor. The second reactor is kept at 170° C. with vigorous mechanical stirring, and after 60 minutes the mixture is conveyed to a basket filter where all solid particles are removed and returned to the second reactor, with the bio-oil being subsequently pumped into a storage tank. The obtained bio-oil presented 0.70% of water and 0.61% of ashes. The bio-oil was obtained with a 93% yield. The overall process is conducted under inert atmosphere by injecting nitrogen at 3.9 m3/h.

### Example 2

In an initial phase, 600 kg of pine tree bark, with 18% of moisture, reduced to particles with 25 mm granulometry, were slowly and continuously added, through a feeder screw where 25% of a 1.5% solution of trichloroacetic acid in solketal is introduced, into a first reactor containing 200 kg of solketal and at a temperature of 165° C., with mechanical stirring. After 80 minutes the mixture is pumped into a basket filter where solid particles larger than 7 mm are separated, which are returned to the first reactor, while the liquid fraction and particles smaller than 7 mm are conveyed to a second reactor. The second reactor is kept at 165° C. with vigorous mechanical stirring, and after 55 minutes the mixture is conveyed to a basket filter where all solid particles are removed and returned to the second reactor, with the bio-oil being subsequently pumped into a storage tank. The obtained bio-oil presented 0.62% of water and 0.91% of ashes. The bio-oil was obtained with a 91% yield. The overall process is conducted under inert atmosphere by injecting nitrogen at 3.5 m^{3/}h.

### Example 3

In an initial phase, 600 kg of pine wood residues, with 25% of moisture, were reduced to particles of 35 mm granulometry, were slowly and continuously added, through a feeder screw where 20% of a 0.75% solution of trichloroacetic acid in glycerol carbonate is introduced, into a first reactor containing 200 kg of glycerol carbonate and at a temperature of 135° C., with mechanical stirring. After 90 minutes the mixture is pumped into a basket filter where solid particles larger than 7 mm are separated, which are returned to the first reactor, while the liquid fraction and particles smaller than 7 mm are conveyed to a second reactor. The second reactor is kept at 135° C. with vigorous mechanical stirring, and after 60 minutes the mixture is conveyed to a basket filter where all solid particles are removed and returned to the second reactor, with the bio-oil being subsequently pumped into a storage tank. The obtained bio-oil presented 0.34% of water and 0.41% of ashes. The bio-oil was obtained with a 97% yield. The overall process is conducted under inert atmosphere by injecting nitrogen at 4.5 m³/h.

### Example 4

In an initial phase, 700 kg of pinecones, ground and sieved at 50 mm, were added, through a feeder screw, where a mixture of 1% trichloroacetic acid in turpentine is also introduced, into a first reactor containing 210 kg and at a temperature of 160° C., with mechanical stirring. After 75 minutes the mixture is pumped into a basket filter where solid particles larger than 7 mm are separated, which are returned to the first reactor, while the liquid fraction and particles smaller than 7 mm are conveyed to a second reactor. The second reactor is kept at 170° C. with vigorous mechanical stirring, and after 60 minutes the mixture is conveyed to a basket filter where all solid particles are removed and returned to the second reactor, with the bio-oil being subsequently pumped into a storage tank. The obtained bio-oil presented 0.82% of water and 0.89% of ashes. The bio-oil was obtained with a 91% yield Then, the obtained liquid product is fed to a distillation column at atmospheric pressure. Three fractions are obtained. One in the range 100-200° C. (10%), another in the range above 200° C. and below 300° C. (32%), and a solid fraction that corresponds to the bituminous that remains in the bottom of the column (58%).

1-6. (canceled)

7. A process of catalytic cracking of waste originating from pine processing industry, which may, or not, contain plastics, paper or glue residues for obtaining chemical products, which are stable, sustainable and cost-effective, comprising the following steps:
a) grinding waste originating from pine processing industry into a particle size between 0.5 mm and 75 mm;
b) spraying a solution of a solvent selected, from crude glycerol and glycerol derivatives, lactates and respective citrates, fatty acids, Tall oil, as well as esters or lactones thereof, glycerol carbonate, solketal among others, said solvents being used pure or in mixtures, and a catalyst in homogeneous phase over the waste originating from pine processing industry;
c) introducing the mixture of step b) into a first reactor at temperatures between 80° C. and 250° C.;
d) maintaining the mixture of step b) under vigorous stirring at atmospheric pressure in a first reactor for a period of time between 30 minutes and 180 minutes;
e) removing the solid residues obtained from the mixture of step d) by physical processes;
f) reintroducing the solid residues obtained in step e) into the first reactor;
g) introducing the liquid fraction obtained in step e) into a second reactor at temperatures between 80° C. and 250° C.;
h) maintaining the liquid fraction of step e) in the second reactor for a period of time between 30 minutes and 180 minutes;
i) removing the solid residues obtained from the mixture of step h) by physical processes;
j) storing the liquid mixture obtained in step i) in a storage tank, the liquid mixture i.e. bio-oil;
wherein, in order to avoid thermo-oxidative degradation, all the process is carried out under a nitrogen atmosphere with flow rates between 3 m3/h and 5 m3/h.

8. The process according to claim 7, further comprising:
k) washing the liquid fraction obtained in step i) with water;
l). separating the aqueous and organic phases obtained in step k);
m) drying by distillation, at atmospheric pressure and single column, the organic fraction obtained in step 1);
n) fractionating the dried organic fraction obtained in step m) by fractional distillation, with a plate column, under vacuum and at temperatures between 100° C. and 250° C.; and
o) storing in tanks the distilled fractions obtained in step n) and from the aqueous fraction in step k).

9. The process according to claim 7, wherein in step c) the first reactor is at temperatures, preferably between 120 and 170° C.

10. The process according to claim 7, wherein the waste originating from pine processing industry may have a moisture content between 5% and 55%, may, or not, contain plastics, paper or glue residues, includes: pine bark, pinecones, pine nut shells, sawdust, abrasion dust from chipboards, pine chips, waste originating from manufacture of pine wood furniture, pine needles, stumps, among others.

11. The process according to claim 7, wherein solketal, glycerol carbonate, glycerol formate, glycerol, Tall oil are employed as solvents.

12. The process according to claim 7 wherein the catalytic cracking occurs in steps b), c), d), e), g) and h) with a catalyst in homogeneous phase selected from trichloroacetic acid, nitric acid, hydrofluoric acid, sulfuric acid, p-toluenesulphonic acid, triflic acid and, generally peracids and superacids, metal or semimetal carbonates in an amount varying between 0.05% and 1.5% (w/w) of weight of catalyst relative to the total weight of the reaction mixture.
